(19) United States
(12) Patent Application Publication
(10) Pub. No.: US 2015/0283503 A1
(43) Pub. Date: Oct. 8, 2015

(54) METHOD AND UNIT FOR REMOVING OXYGEN FROM A GAS FLOW COMPRISING CO2

(71) Applicant: L'AIR LIQUIDE, SOCIETE ANONYME POUR L'ETUDE ET L'EXPLOITATION DES PROCEDES GEORGES CLAUDE, Paris (FR)

(72) Inventors: Nicolas Chambron, Nogent Sur Marne (FR); Arthur Darde, Paris (FR); Richard Dubettier-Grenier, La Varenne Saint Hilarie (FR); Matthieu Leclerc, Paris (FR)

(21) Appl. No.: 14/438,309

(22) PCT Filed: Sep. 18, 2013
(86) PCT No.: PCT/FR2013/052147

§ 371 Date: Apr. 24, 2015

(30) Foreign Application Priority Data
Oct. 25, 2012 (FR) 1260181

(51) Int. Cl. B01D 53/86

(52) U.S. Cl. CPC B01D 53/8671; B01D 53/8693; B01D 2255/1023; B01D 2255/1021; B01D 2257/104

(57) ABSTRACT

The invention relates to a method and apparatus for the oxygen purification of a supply gas flow comprising at least 45% CO2 and at least 10% oxygen, said method includes the steps of catalytically oxidizing the supply gas flow in the presence of a fuel and recovering the oxygen-depleted gas flow.

### CROSS REFERENCE TO RELATED APPLICATIONS

This application is a §371 of International PCT Application PCT/FR2013/052147, filed Sep. 18, 2013, which claims the benefit of FR1260181, filed Oct. 25, 2012, both of which are herein incorporated by reference in their entireties.

### TECHNICAL FIELD OF THE INVENTION

The present invention relates to a process and a plant for removing oxygen from a gas stream comprising at least 45% of carbon dioxide, more particularly more than 80% of carbon dioxide. The invention applies particularly to the purification of a gas stream resulting from an oxy-combustion process, more particularly from an oxy-combustion process under pressure of between 10 and 50 bar, comprising a content thereof of the order of a percent, preferably less than 10%.

### BACKGROUND

Climate change constitutes one of the greatest environmental challenges. The increase in the concentration of carbon dioxide in the atmosphere is in very large part the cause of global warming CO₂ of human origin is essentially emitted into the atmosphere by the combustion of fossil fuels in power plants.

Power plants make it possible, by combustion of fuels, to give off the heat which can be used to produce steam and optionally mechanical or electrical energy. The combustion flue gases release large amounts of CO₂ into the atmosphere.

In order to provide for the purification of the CO₂-rich gas stream, for the purpose mainly of burying it or also of using it for EOR (Enhanced Oil Recovery), it is advisable in particular to reduce the oxygen content to values of the order of a ppm(v). In order to do this, use is generally made either of a stage of chemical purification (such as washing with amines, Rectisol, and the like, for example) or a stage of cryogenic separation/purification (comprising in particular a distillation column)

The processes currently used to purify a CO₂ gas stream make it possible not only to reduce the oxygen content to low values but also make possible the purification of other impurities, such as, for example, carbon monoxide, argon, nitrogen, and the like.

In the specific case of oxy-combustion under pressure, the oxygen content of the gas to be treated is lower than that commonly observed in the flue gases from a conventional oxy-combustion process (of the order of a % versus 5-10% conventionally) and the CO₂ purity is already very high: more particularly of greater than 80%.

Thus, the purification in oxygen alone to contents of the order of a ppm(v) may suffice to achieve the specifications required with regard to the CO₂ produced, for the purpose of subsequently burying it or using it for EOR (Enhanced Oil Recovery), for example.

Taking this as the starting point, a problem which is posed is that of providing an improved process for the purification of a gas feed stream comprising at least 45% of CO₂.

### SUMMARY OF THE INVENTION

A solution of the present invention is a process for the purification in oxygen of a gas feed stream 1 comprising at least 45% of CO₂ and less than 10% of oxygen, said process comprising:
a) a stage of catalytic oxidation 3, 4 of the gas feed stream 1 in the presence of a fuel, and
b) a stage of recovery of an oxygen-depleted gas stream 7.

To use a stage of catalytic oxidation in order to remove the oxygen from the gas stream to be treated makes it possible not only to recover the heat from the stream exiting from the oxy-combustion plant (by integrating the stage of catalytic oxidation directly with regard to the hot stream) but also to recover the pressure from this same stream, in the case in particular of an oxy-combustion under pressure (at a pressure of between 10 and 50 bar), where the gas stream to be treated is at a pressure greater than atmospheric pressure, which makes it possible to subsequently reduce the compression of the purified CO₂, for the purpose of burying it or using it for EOR (Enhanced Oil Recovery) applications, for example.

As the case may be, the present invention can exhibit one or more of the following characteristics:
the oxygen concentration of said gas feed stream 1 is less than 5%, preferably less than 2%;
the CO₂ concentration of said gas feed stream 1 is greater than 45%, preferably greater than 80%;
the water produced during the stage a) of catalytic oxidation 3, 4 is removed in a desiccation module 6;
the stage a) of catalytic oxidation 3,4 is carried out at a temperature of between 100° C. and 800° C. This is because, according to the catalyst and the fuel gas chosen (and thus the operating temperature required), the gas feed stream does or does not have to be preheated, depending on its integration and on the outlet temperature of the oxy-combustion plant;
the fuel gas is methane and/or hydrogen; this choice will be arbitrated by economic criteria but also by the oxygen content required at the cylinder outlet: methane (relatively inexpensive gas) does not make it possible to get down to oxygen contents of less than about a thousand ppm(v), indeed even than about 100 ppm(v), because of the risk of reforming of the methane, whereas hydrogen (more expensive gas) for its part makes it possible to achieve ppm(v) in oxygen;
the stage of catalytic oxidation 3, 4 is carried out in a catalytic oxidation unit comprising a catalytic bed composed of a catalyst, typically a matrix based on aluminum activated with palladium and/or platinum;
the stage of catalytic oxidation is carried out in a catalytic oxidation unit comprising two reactors in series: a first reactor 3 comprising a first catalytic bed and employing a first fuel, and a second reactor 4 comprising a second catalytic bed and employing a second fuel.

In the case of the use of two reactors in series, the second reactor can be operated at the outlet temperature of the first reactor;
the gas stream recovered at the outlet of the first reactor 3 exhibits an oxygen concentration of between 1500 and 100 ppm(v), preferably between 1000 and 500 ppm(v);
the gas stream recovered at the outlet of the second reactor 4 exhibits an oxygen concentration of less than 100 ppm(v), preferably less than 1 ppm(v);
the first fuel is methane;
the second fuel is hydrogen;
the gas stream recovered in stage b) has a temperature of between 800° C. and 100° C., more particularly between 600° C. and 200° C., and said process comprises, downstream of stage b), a stage c) of recovery of the heat 5. The stage a) of catalytic oxidation is an exothermic stage and the gas feed stream, which was at a temperature of between 100° C. and 800° C., experienced a rise in this temperature during stage a). This recovery of heat can make it possible to preheat boiler feed water, for example, but can also be used to preheat the gas to be treated upstream of the first reactor, if the temperature required is greater than the outlet temperature of the oxy-combustion plant;
the gas feed stream 1 is a stream of oxy-combustion flue gases, preferably from oxy-combustion at a pressure of between 10 and 50 bar.

It should be noted that, in the case where a more intensive purification would be necessary (in particular regarding the other impurities present in the gas to be treated), a cryogenic purification unit can be used downstream of the stage of catalytic oxidation.

Another subject matter of the present invention is a plant for the purification of a gas feed stream comprising at least 45% of CO₂ and less than 10% of oxygen, said plant comprising:
(i) a reheater 2 for heating the gas feed stream 1 to a temperature of between 400° C. and 500° C.,
(ii) a first catalytic oxidation reactor 3 which makes possible the combustion of the oxygen of the reheated gas stream in the presence of methane,
(iii) a second catalytic oxidation reactor 4 which makes possible the combustion of the oxygen of the gas stream resulting from the first catalytic oxidation reactor 3 in the presence of hydrogen,
(iv) a heat recovery unit 5 which makes it possible to recover the heat of reaction of the gas stream exiting from the second catalytic oxidation reactor 4, and
(v) a desiccation module 6 which makes it possible to dry the gas stream exiting from the heat recovery unit 5.

According to an alternative form of the present invention, the plant comprises only a single catalytic oxidation reactor which makes possible the combustion of the oxygen of the reheated gas stream in the presence of hydrogen.

In other words, according to this alternative form, the plant according to the invention comprises:
(i) a reheater 2 for heating the gas feed stream 1 to a temperature of between 400° C. and 500° C.,
(ii) a catalytic oxidation reactor 4 which makes possible the combustion of the oxygen of the reheated gas stream in the presence of hydrogen,
(iii) a heat recovery unit 5 which makes it possible to recover the heat of reaction of the gas stream exiting from the catalytic oxidation reactor 4, and
(iv) a desiccation module 6 which makes it possible to dry the gas stream exiting from the heat recovery unit 5.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 shows an embodiment of the invention.

FIG. 2 shows an embodiment of the invention.

### DETAILED DESCRIPTION

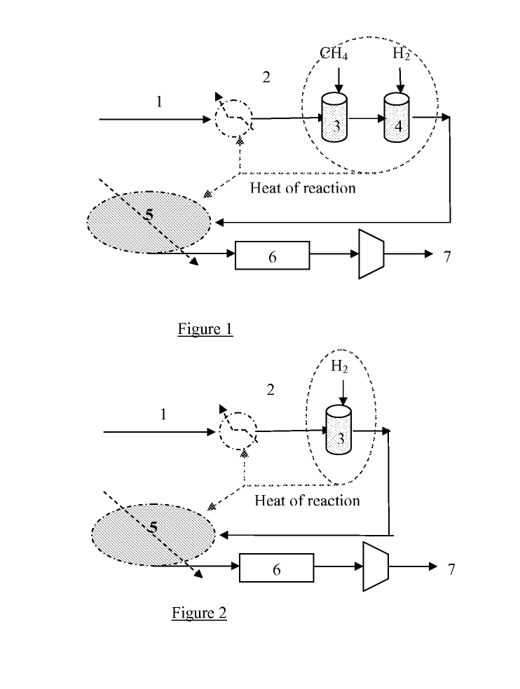

The invention will now be described in more detail with the help of FIGS. 1 and 2.

FIG. 1 gives a diagrammatic representation of a process according to the invention in which the catalytic oxidation unit comprises a first reactor comprising a first catalytic bed and a second reactor comprising a second catalytic bed. The gas feed stream 1 is optionally reheated in a heat exchanger 2 (depending on the outlet temperature of the oxy-combustion plant and on the temperature required in the first reactor) to a temperature of between 400° C. and 500° C. (for the present case using methane in the first reactor). The optionally reheated gas stream enters the first catalytic oxidation reactor 3 in which the fuel used is methane. This first reactor 3 makes it possible to obtain an oxygen concentration of the order of 1000 ppm(v). Thus, this first stage of catalytic oxidation makes it possible to overcome the problem of cracking of the methane (reforming of the methane) which may take place when the temperature becomes too high, which appears in particular when the oxygen content is less than 1000 ppm(v), indeed even than about 100 ppm(v). The gas stream subsequently enters the second catalytic oxidation reactor 4 in which the fuel used is hydrogen. Hydrogen is a fuel gas which makes it possible to obtain an oxygen concentration of the order of a ppm(v). The oxygen-depleted gas stream is subsequently introduced into a heat recovery unit 5, for example an exchanger for feeding the steam network, or also an exchanger which makes it possible to take advantage of the heat of reaction to preheat the gas entering the first catalytic oxidation reactor, before being subjected to a drying stage 6 targeted at removing the water produced during the catalytic oxidation stage. Also, the presence of the heat recovery unit can make it possible to envisage the case where, after initiating the catalytic reactions, the heat exchanger 2 is no longer used and the gas stream entering the first reactor is heated solely by means of the heat recovery unit 5. Finally, the gas stream can optionally be subjected to several treatment stages before being compressed and recovered. The gas stream 7 thus recovered comprises more than 90% of CO₂.

FIG. 2 diagrammatically represents a process according to the invention in which the catalytic oxidation unit comprises a single reactor comprising a catalytic bed and employing hydrogen as fuel. The gas feed stream 1 is optionally reheated in a heat exchanger 2 (depending on the outlet temperature of the oxy-combustion plant and on the temperature required in the first reactor) to a temperature of between 90° C. and 150° C. (for the present case using hydrogen in the first reactor). The reheated gas stream then enters the catalytic oxidation reactor 3. Hydrogen is an efficient fuel gas and makes it possible to obtain an oxygen concentration of the order of a ppm(v). The oxygen-depleted gas stream is subsequently introduced into a heat recovery unit 5, for example an exchanger for feeding the steam network, or also an exchanger which makes it possible to take advantage of the heat of reaction to preheat the gas entering the catalytic oxidation reactor 3, before being subjected to a drying stage 6 targeted at removing the water produced during the catalytic oxidation stage. Also, the presence of the heat recovery unit can make it possible to envisage the case where, after initiating the catalytic reactions, the heat exchanger 2 is no longer used and the gas stream entering the first reactor is heated solely by means of the heat recovery unit 5. Finally, the gas stream can optionally be subjected to several treatment stages before being compressed and recovered. The gas stream 7 thus recovered comprises more than 90% of CO₂.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A process for the purification in oxygen of a gas feed stream comprising at least 45% of CO₂ and less than 10% of oxygen, said process comprising the steps of:
a) reacting the gas feed stream in a stage of catalytic oxidation in the presence of a fuel, the fuel being selected from the group consisting of methane, hydrogen and combinations thereof; and
b) recovering an oxygen-depleted gas stream.

17. The process as claimed in claim 16, wherein the oxygen concentration of said gas feed stream is less than 5%.

18. The process as claimed in claim 16, wherein the CO₂ concentration of said gas feed stream is greater than 80%.

19. The process as claimed in claim 16, wherein the water produced during the stage a) of catalytic oxidation is removed in a desiccation module.

20. The process as claimed in claim 16, wherein the step a) of catalytic oxidation is carried out at a temperature of between 100° C. and 800° C.

21. The process as claimed in claim 16, wherein the stage of catalytic oxidation is carried out in a catalytic oxidation unit comprising a catalytic bed composed of a catalyst based on palladium and/or platinum.

22. The process as claimed in claim 16, wherein the stage of catalytic oxidation is carried out in a catalytic oxidation unit comprising two reactors in series:
a first reactor comprising a first catalytic bed and employing a first fuel, the first reactor having an outlet configured to recover a first outlet gas stream; and
a second reactor comprising a second catalytic bed and employing a second fuel, the second reactor having a second outlet configured to recover a second outlet gas stream.

23. The process as claimed in claim 22, wherein the gas stream recovered at the outlet of the first reactor exhibits an oxygen concentration of between 1500 and 100 ppm(v).

24. The process as claimed in claim 22, wherein the gas stream recovered at the second outlet of the second reactor exhibits an oxygen concentration of less than 100 ppm(v).

25. The process as claimed in claim 23, wherein the first fuel is methane.

26. The process as claimed in claim 23, wherein the second fuel is hydrogen.

27. The process as claimed in claim 16, wherein the gas stream recovered in stage b) has a temperature of between 800° C. and 100° C., and said process comprises, downstream of step b), a step c) of recovery of the heat produced during step a).

28. The process as claimed in claim 16, wherein the gas feed stream is a stream of oxy-combustion flue gases.

29. A plant for the purification of a gas feed stream comprising at least 45% of CO₂ and less than 10% of oxygen, said plant comprising:
(i) a reheater configured to heat the gas feed stream to a temperature of between 400° C. and 500° C.;
(ii) a first catalytic oxidation reactor in fluid communication with, and downstream of, the reheater, the first catalytic oxidation reactor configured to combust the oxygen of the gas stream in the presence of methane to produce a first reaction stream, wherein the first reaction stream has a reduced amount of oxygen as compared to the gas feedstream;
(iii) a second catalytic oxidation reactor in fluid communication with, and downstream of, the first catalytic oxidation reactor, the second catalytic oxidation reactor configured to combust the oxygen of the first reaction stream in the presence of hydrogen to produce a second reaction stream, wherein the second reaction stream has a reduced amount of oxygen as compared to the first reaction stream;
(iv) a heat recovery unit configured to recover the heat of reaction of the second reaction stream ; and
(v) a desiccation module configured to dry the second reaction stream exiting from the heat recovery unit.

30. A plant for the purification of a gas feed stream comprising at least 45% of CO₂ and less than 10% of oxygen, said plant comprising:
(i) a reheater configured to heat the gas feed stream to a temperature of between 400° C. and 500° C.;
(ii) a catalytic oxidation reactor in fluid communication with, and downstream of, the reheater, the first catalytic oxidation reactor configured to combust the oxygen of the gas stream in the presence of hydrogen to produce a reaction stream, wherein the first reaction stream has a reduced amount of oxygen as compared to the gas feedstream;
(iii) a heat recovery unit configured to recover the heat of reaction of the reaction stream exiting from the catalytic oxidation reactor; and
(iv) a desiccation module configured to dry the reaction stream exiting from the heat recovery unit.
